(19) United States
(12) Patent Application Publication
(10) Pub. No.: US 2011/0238957 A1
(43) Pub. Date: Sep. 29, 2011

(54) SOFTWARE CONVERSION PROGRAM PRODUCT AND COMPUTER SYSTEM

(75) Inventors: Yusuke SHIROTA, Kanagawa (JP); Osamu Torii, Tokyo (JP)

(73) Assignee: KABUSHIKI KAISHA TOSHIBA, Tokyo (JP)

(21) Appl. No.: 12/881,422

(22) Filed: Sep. 14, 2010

(30) Foreign Application Priority Data
Mar. 26, 2010 (JP) 2010-073698

(51) Int. Cl. G06F 9/302; G06F 9/44; G06F 9/312

(52) U.S. Cl. 712/221; 712/241; 712/E09.017; 712/E09.033

(57) ABSTRACT

According to one embodiment, a software conversion program product having a computer readable medium including programmed instructions, wherein the instructions, when executed by a computer system including a host processor and one or more accelerator processors, causes the computer system to perform: analyzing input software and obtaining a compute intensity calculated by dividing the number of arithmetic processing times in a loop by the size of data accessed in the loop and a data reference area size that is a total size of areas where data is referred to; determining a processor that executes loops on the basis of obtained values and a preliminarily prepared win-loss table in which wins and losses of execution times between the host processor and the accelerator processor are defined; and converting the input software so that the determined processor executes the loops.

### CROSS-REFERENCE TO RELATED APPLICATIONS

This application is based upon and claims the benefit of priority from Japanese Patent Application No. 2010-073698, filed on Mar. 26, 2010; the entire contents of which are incorporated herein by reference.

### FIELD

Embodiments described herein relate generally to a software conversion program for quickly processing software which is to be executed by a computer.

### BACKGROUND

In recent computer systems, a technique for reducing execution time of an entire program by moving arithmetic processing, which is included in software to be executed and requires high arithmetic processing performance, from a host processor to an accelerator such as a GPGPU (General Purpose GPU) that uses a Graphics Processing Unit (GPU) not only for graphics processing but also for general calculation, a CELL processor, and a DSP and executing the arithmetic processing attracts attention. Hereinafter, the moving and executing operation is referred to as “off-load”.

For example, if a C language compiler disclosed in PGI Fortran & C Accelerator Programming Model v1.0, The Portland Group, June 2009 is used, loop processing included in input software can be off-loaded to an accelerator.

To off-load arithmetic processing to an accelerator, data necessary for the arithmetic processing needs to be transferred to a device memory of the accelerator in advance.

Therefore, a software developer needs to consider, when developing the software, whether the arithmetic processing should be off-loaded to an accelerator. When it is determined to off-load the arithmetic processing, off-load processing needs to be included in the software in advance. Generally, software developers determine whether to off-load arithmetic processing to an accelerator on the basis of a value obtained by dividing “the number of arithmetic processing times in a loop” by “the size of data accessed in the loop” (=“arithmetic processing density”).

However, when a computer system executes software, a change of actual data transfer rate due to change of the size of transferred data, an influence of cache behavior in a host processor, and the like occur. Therefore, it is difficult for a software developer to develop software considering the above issues, and even if the software developer develops software considering the above issues, it is unclear whether the speed of the arithmetic processing is actually improved.

### BRIEF DESCRIPTION OF THE DRAWINGS

FIG. 1 is a diagram illustrating a computer system to which an embodiment is applied;

FIG. 2 is a flowchart showing the entire embodiment;

FIG. 3 is a diagram showing an example of a generated data transfer time table;

FIG. 4 is an operation flowchart of a win-loss table generation program;

FIG. 5 shows an example of a test program;

FIG. 6 shows an example of a win-loss table specified by <data-reference-area overlap rate parameter, data-reference-area size parameter>=<50%, 6000>;

FIG. 7 is a diagram showing a configuration of a software conversion program;

FIG. 8 shows an example of input software;

FIG. 9 shows an example of data-reference-area information;

FIG. 10 shows an example of data-transfer-area information;

FIG. 11 is a flowchart for obtaining a data-reference-area size parameter;

FIG. 12 shows an example of merged data-reference-area information and data-reference-area size parameter;

FIG. 13 is a flowchart for obtaining a data-reference-area overlap rate parameter;

FIG. 14 is a flowchart for obtaining a data transfer rate parameter;

FIG. 15 is a diagram showing a win-loss table obtained by interpolating the win-loss table; and

FIG. 16 shows an example of generated output software.

### DETAILED DESCRIPTION

In general, according to one embodiment, a software conversion program product having a computer readable medium including programmed instructions, wherein the instructions, when executed by a computer system including a host processor and one or more accelerator processors, causes the computer system to perform: analyzing input software and obtaining a compute intensity calculated by dividing the number of arithmetic processing times in a loop by the size of data accessed in the loop and a data reference area size that is a total size of areas where data is referred to; determining a processor that executes loops on the basis of obtained values and a preliminarily prepared win-loss table in which wins and losses of execution times between the host processor and the accelerator processor are defined; and converting the input software so that the determined processor executes the loops.

An embodiment will be described in detail with reference to the accompanying drawings.

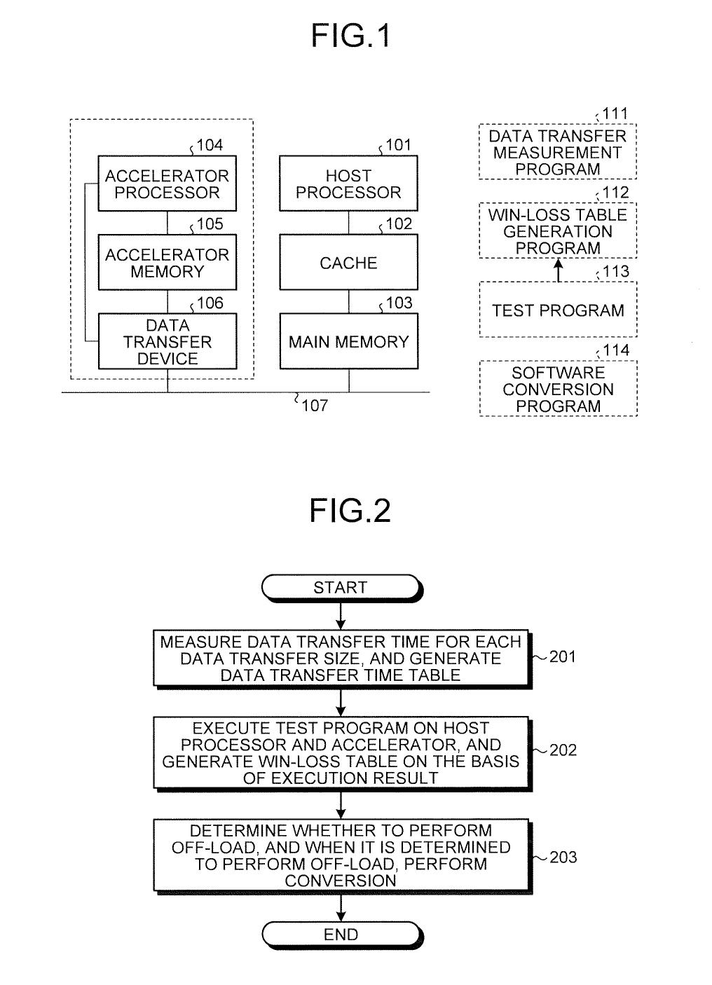

FIG. 1 shows a computer system to which the embodiment is applied. The computer system includes a host processor 101, a cache 102, a main memory 103, an accelerator processor 104, an accelerator memory 105, and a data transfer device 106. The data transfer device 106 and the main memory 103 are connected to each other via a bus 107. Although, in the embodiment, the computer system includes one set of the accelerator processor 104, the accelerator memory 105, and the data transfer device 106, the computer system may include two or more sets of them. Although not shown in FIG. 1, the computer system includes a secondary storage device such as an HDD or a semiconductor storage device including a non-volatile memory, and, of course, may include input devices such as a keyboard and a mouse, a display device, and the like.

The embodiment is realized by installing a data transfer measurement program 111, a win-loss table generation program 112, and a software conversion program 114 in the computer system, and executing these programs.

The programs will be described with reference to an entire flowchart of the embodiment in FIG. 2.

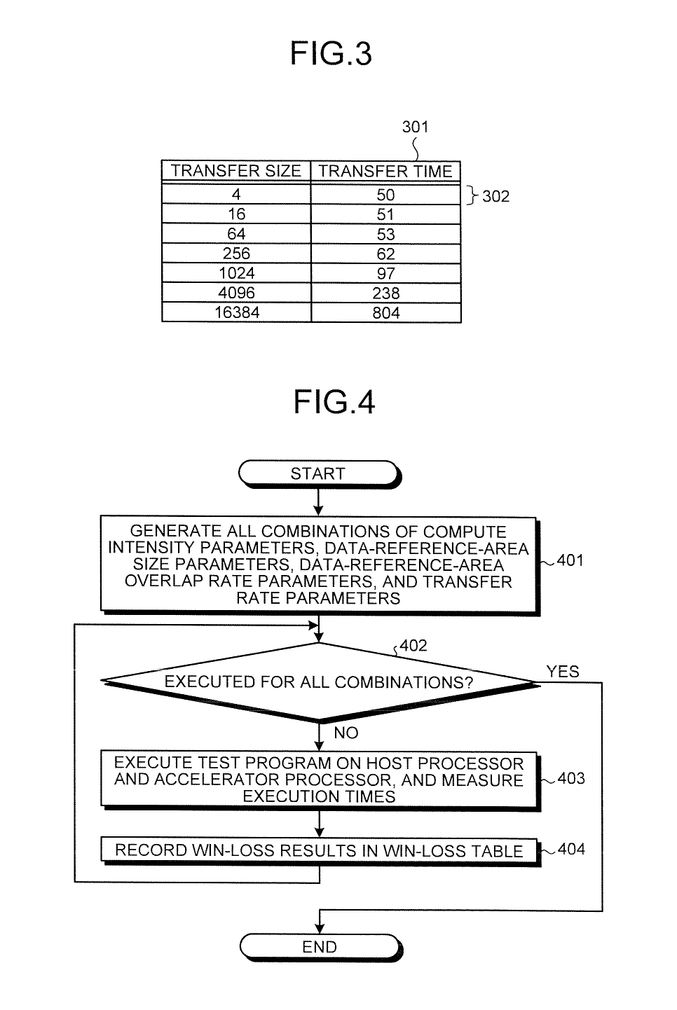

When the data transfer measurement program 111 is executed on the computer system, a plurality of data having different data sizes are moved from the main memory 103 to the accelerator memory 105, transfer times of each data are measured, and the data size and the transfer time of each data are associated with each other and recorded, and thus a data transfer time table is generated (step 201). FIG. 3 shows an example 301 of the generated data transfer time table. Each entry 302 of the data transfer time table 301 includes a pair of transfer size and transfer time. The data size of measured data may be a discrete value, and when there is not a data size desired to be known in the data transfer time table 301, an interpolated value may be used by performing a linear interpolation or the like. The data transfer measurement program 111 is executed (step 201), for example, when the data transfer measurement program 111 is installed in the computer system.

Next, the win-loss table generation program 112 is executed on the computer system. A test program 113 is executed by both the host processor 101 and the accelerator processor 104, and it is measured which processor of the processors 101 and 104 executes the test program 113 faster. Then, a win-loss table showing the measurement result is generated (step 202). If there is a plurality of accelerator processors 104, the above processing is performed for each accelerator processor 104, and win-loss tables, the number of which corresponds to the number of the accelerator processors 104, are generated. Details of the operation of the win-loss table generation program 112 will be described later. The win-loss table generation program 112 is executed after the data transfer time table is generated and when the win-loss table generation program 112 is installed in the computer system, for example.

Next, when the software conversion program 114 is executed on the computer system, it is determined whether loop processing included in input software to be executed on the computer system by a user should be off-loaded to the accelerator processor 104 by referring to the win-loss table. When it is determined that the loop processing should be off-loaded, the input software is converted (step 203). Details of the operation of the software conversion program 114 will be described later.

By the above-described flow, because the win-loss table based on the actual operation of the computer system, such as data transfer rate and influence of cache behavior in a host processor, is used, it is possible to more correctly determine whether to perform off-load.

Hereinafter, the operation of the win-loss table generation program 112 will be described in detail. The win-loss table generation program 112 generates the win-loss table, which is used to determine whether to perform off-load, by executing the test program 113 while changing a combination of four parameters “compute intensity parameter”, “data-reference-area size parameter”, “data-reference-area overlap rate parameter”, and “data transfer rate parameter”. Details of the parameters will be described later.

FIG. 4 shows an operation flowchart of the win-loss table generation program 112.

First, the win-loss table generation program 112 generates all combinations of the parameters (step 401). For example, when the four parameters include “three compute intensity parameters: 1, 3, and 5”, “two data-reference-area size parameters: 600 and 6000”, “three data transfer rate parameters: 1.0, 1.8, and 4.7”, and “two data-reference-area overlap rate parameters: 0 and 50”, the number of combinations (the number of all the combinations) is 3×2×3×2=36. The number of all the combinations of the parameters may be obtained in advance and recorded in the win-loss table generation program 112 in advance.

Next, the win-loss table generation program 112 checks whether the test program 113 is executed for all the combinations of the parameters (step 402). If the result of this step is Yes, the processing of the operation ends, and the generation of the win-loss table is completed.

Conversely, if the result of this step is No, in other words, if processing for all the combinations of the parameters has not been completed, the win-loss table generation program 112 selects a combination from combinations that have not yet been used to perform the processing, executes the test program 113 on both the host processor 101 and the accelerator processor 104 by using the selected combination of the parameters, and measures respective execution times of these processors (step 403).

The win-loss table generation program 112 records the shorter execution time of the two execution times measured in step 403 in a corresponding entry in the win-loss table as the winner (step 404). Then, the win-loss table generation program 112 returns to step 402.

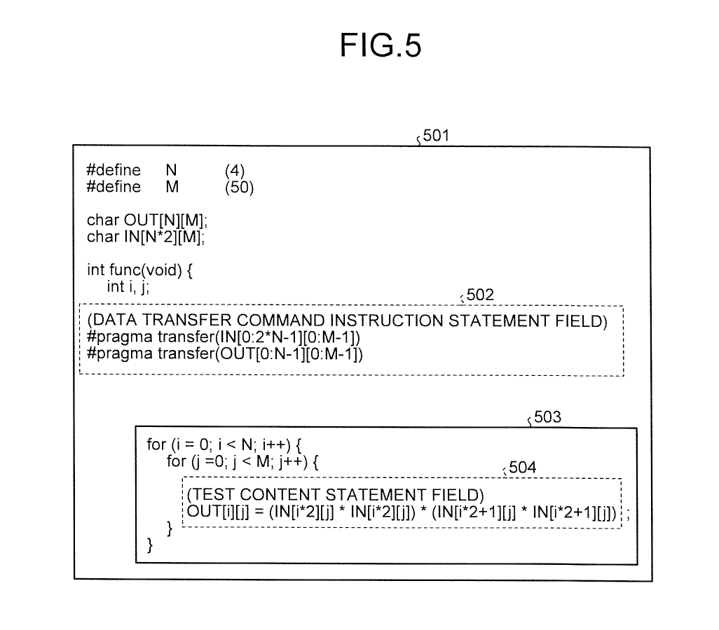

FIG. 5 shows an example 501 of the test program 113. Although the test program 501 is written using the C language, other programming languages may be used.

The test program includes a nested-loop 503, and refers to array variables IN and OUT in the nested-loop 503.

A data transfer instruction statement field 502 is not written in the test program executed by the host processor 101, but written in the test program executed by the accelerator processor 104. The data transfer instruction statement field 502 is a data transfer instruction statement for transferring data to the accelerator memory 105 so as to execute the test program on the accelerator processor 104. The data transfer instruction statement is represented as, for example, #pragma transfer ( ) and specifies data transfer range in an argument. The data transfer is performed for each range. An array range specified by the data transfer instruction statement is specified in a form of partial array. For example, the array range is represented by “array variable name [first-dimensional start index number: first-dimensional end index number] [second-dimensional start index number: second-dimensional end index number]”. The data transfer range IN[0:2*N−1][0:M−1] in FIG. 5 represents a range from IN[0] [0] to IN[2*N−1][M−1].

A test content statement is inserted in a test content field 504.

Hereinafter, the four parameters mentioned above will be described.

The “compute intensity parameter” is a value obtained by dividing the “the number of arithmetic processing times in a loop” by “the size of data accessed in the loop”. The “compute intensity parameter” is changed by changing the test content statement inserted in the test content statement field 504. For example, when the test content statement is OUT[i][j]=(IN[i*2][j]*IN[i*2][j])*(IN[i*2+1][j]*IN[i*2+1][j]); shown in FIG. 5, two elements of the array variable IN are squared respectively and then multiplied by each other, and the results are assigned to corresponding elements in the array variable OUT, so that the compute intensity=3/3=1 because the number of arithmetic processing times in the nested-loop is 3 and the size of data accessed in the loop is 3 elements. When the test content statement is changed so that the two elements of the array variable IN are squared 4 times respectively or 7 times respectively, the number of arithmetic processing times in the nested-loop is changed to 9 times or 15 times respectively. As a result, the compute intensity becomes 3 (=9/3) or 5 (=15/3) respectively.

The “data-reference-area size parameter” is a value indicating total size of areas where data for executing a program is referred to. The “data-reference-area size parameter” is changed by changing “N” that is one-dimensional length of the variables IN and OUT representing a two-dimensional array. When N=4, the data reference area size is 600 because the size is a sum of 200 (=N*M) of the array OUT and 400 of the array IN (=two times the size of OUT). For example, by changing to N=40, the data reference area size can be changed to 6000 because the size is a sum of 2000 (=N*M) of the array OUT and 4000 of the array IN (=two times the size of OUT).

The “data transfer rate parameter” is a value indicating a data transfer rate from the main memory to the accelerator memory. The “data transfer rate parameter” is changed by changing the data transfer instruction statement inserted in the data transfer instruction statement field 502. By #pragma transfer(IN[0:2*N−1][0:M−1]) and #pragma transfer(OUT[0:N−1][0:M−1]) in FIG. 5, the entire array IN and the entire array OUT are respectively transferred. Since the transfer size of the entire array IN=2N*M=400, and the transfer size of the entire array OUT=N*M=200, when the transfer time of transfer size s is represented by t(S), the total transfer time is t(400)+t(200). The average data transfer rate can be obtained by (the transfer size of the entire array IN+the transfer size of the entire array OUT)/(t(400)+t(200)). The average data transfer rate can be calculated to be 4.7 because the transfer time can be obtained as t(400)=69 and t(200)=59 from the data transfer time table 301 by using linear interpolation. For example, it is assumed that, when the data transfer instruction statement is written in four segments such as #pragma transfer(OUT[0:0][0:M−1], OUT[1:1][0:M−1], OUT[2:2][0:M−1], OUT[3:3][0:M−1]), each row is transferred individually. The transfer size of both the array IN and the array OUT is 50, and the average data transfer rate is (the entire size of array IN+the entire size of array OUT)/t(50)*12. It is possible to calculate that t(50)=52 from the data transfer time table 301, so that the data transfer rate can be calculated to be 1.0. Similarly, when the data transfer instruction statement is written in two segments, each data transfer size is 100, and it is possible to calculate that t(100)=55, so that the data transfer rate can be calculated as (the entire size of array IN+the entire size of array OUT)/t(100)*6=1.8.

The “data-reference-area overlap rate parameter” is a value indicating a degree of overlap of data referred to in the loop processing of the test program. The “data-reference-area overlap rate parameter” is changed by changing the test content statement inserted in the test content statement field 504. For example, in the case of the test content statement inserted in the test content statement field 504, every time the variable i is updated, a different row in the array is referred to, so that the overlap rate is 0%. This test content statement is changed to OUT[i][j]=(IN[i][j]*IN[i][j])*(IN[i+2][j]*IN[i+2][j]). In this case, IN[i+2][j] when i=k and IN[i][j] when i=k+1 overlap each other (rows overlap each other), so that it is possible to change the test content statement such that 50% overlap occurs every time.

The win-loss tables 601, the number of which is [the number of samples of the data-reference-area overlap rate parameter×the number of samples of the data-reference-area size parameter], are prepared for each accelerator. For example, when there are two samples 0% and 50% for the data-reference-area overlap rate parameter and there are two samples 600 and 6000 for the data-reference-area size parameter, a total of four win-loss tables are generated. Here, although the win-loss tables are generated for each combination of the data-reference-area overlap rate parameters and the data-reference-area size parameters, the win-loss tables may be generated for each combination of any two parameters of the four parameters.

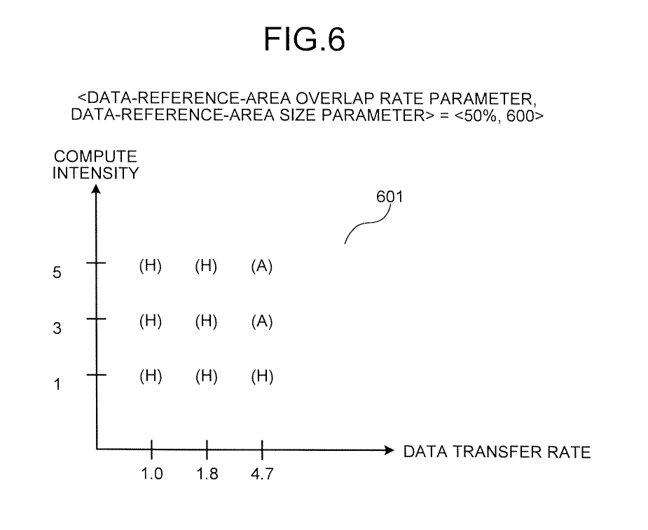

FIG. 6 shows an example of the win-loss table 601 specified by <data-reference-area overlap rate parameter, data-reference-area size parameter>=<50%, 6000>.

In the win-loss table 601, a first axis is “data transfer rate” and a second axis is “compute intensity”. In each entry of the table, (A) or (H) is stored. When the execution time on the accelerator is shorter than the execution time on the host processor (execution is faster when off-load is performed), (A) is stored. On the contrary, when the execution time on the host processor is shorter (execution is slower when off-load is performed), (H) is stored. When referring to the win-loss table, if there is no measured value, an interpolated value may be used by performing simple interpolation.

Hereinafter, the operation of the software conversion program 114 will be described in detail.

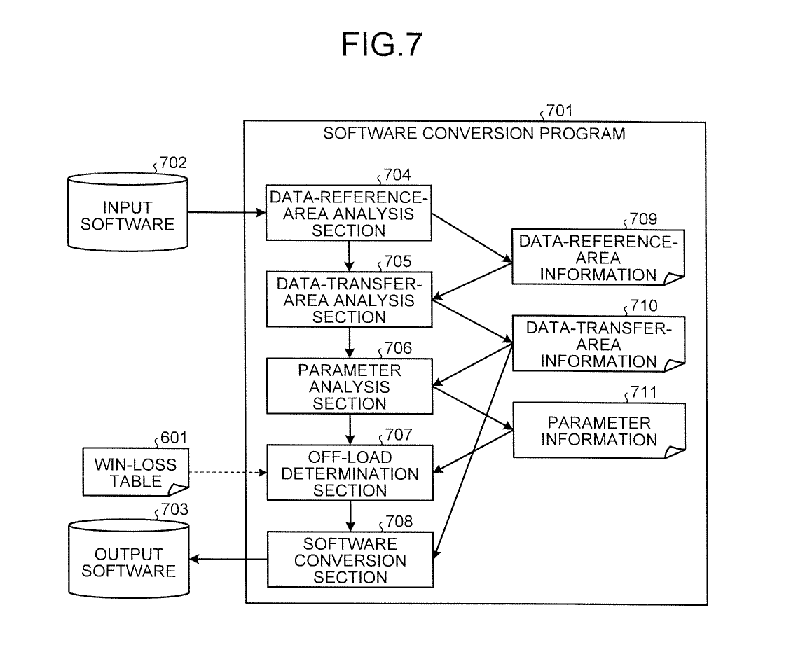

FIG. 7 shows a configuration of an example 701 of the software conversion program 114.

The software conversion program 701 analyzes input software 702 which a user will execute on the computer system, converts the input software 702 as necessary on the basis of the analysis result, and generates and outputs output software 703. A data-reference-area analysis section 704 analyzes the input software 702, extracts each of data areas referred to by the input software 702, and generates data-reference-area information 709.

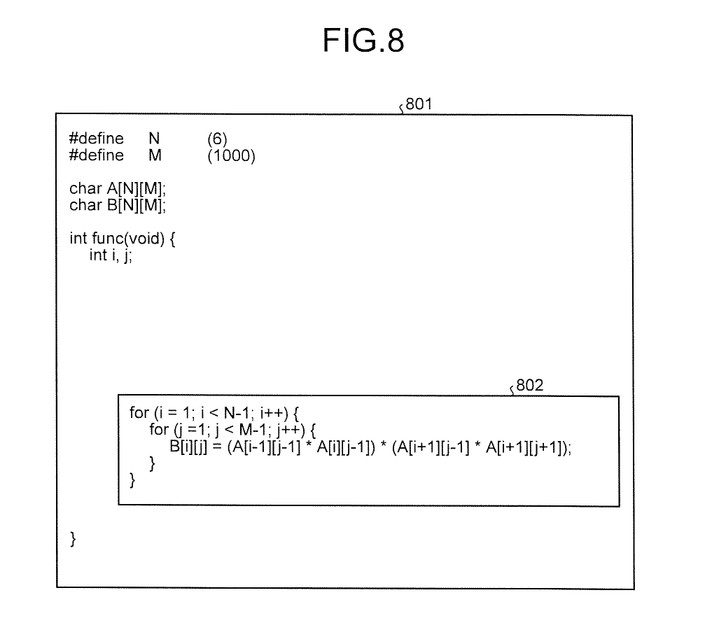

FIG. 8 shows an example of input software. Input software 801 includes a nested-loop 802, and refers to array variables A and B in the nested-loop 802. Although the input software is written using the C language, other programming languages may be used.

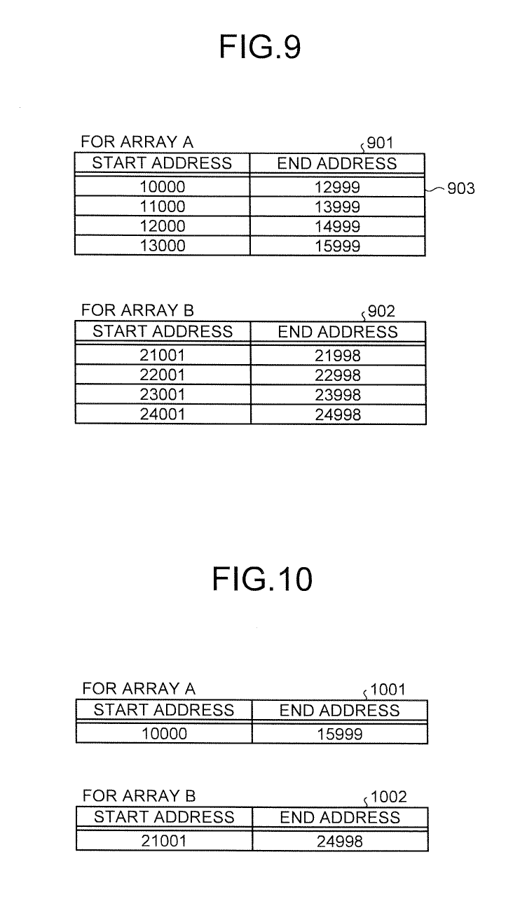

FIG. 9 shows an example of the data-reference-area information 709. A start address and an end address of the data reference area are recorded in each data reference area 903 of data-reference-area information 901 and 902. An example is shown in which, when the start address of the array variable A of the input software is 10000 in the data-reference-area information 901, the start address of the array variable B is 20000 in the data-reference-area information 902.

Next, a data-transfer-area analysis section 705 obtains data transfer time by using the data transfer time table 301 of FIG. 3 generated in advance for each of methods. The methods include method A in which data is transferred for each data reference area on the basis of the generated data-reference-area information 709, method B in which neighboring data reference areas are grouped together on the basis of a predetermined rule and then data is transferred, and method C in which all data reference areas are grouped together on the basis of a predetermined rule and then data is transferred. The data-transfer-area analysis section 705 selects a method which realizes a least data transfer time value, and then, generates data-transfer-area information 710 indicating areas where data is transferred by using the method.

For example, with respect to the array B of the input software 702, the transfer time by the method A is “4*t(998)=4*95.8=383”, and the transfer time by the method B and the method C is “t(3998)=230”. Therefore, it is found that the transfer time is shorter when the method B or the method C is employed. FIG. 10 shows an example of the data-reference-area information obtained as a result of the above.

Details of the processing performed by the data-transfer-area analysis section 705 are described in a document “Yusuke Shirota, et al., Information Processing Society Research Report. High Performance Computing, 2006 (87), pp. 293-298].

Next, a parameter analysis section 706 obtains the data-reference-area size parameter from the data-reference-area information 709, obtains the compute intensity parameter from the input program, obtains the data-reference-area overlap rate parameter from the data-reference-area information 709, obtains the data transfer rate parameter from the data-transfer-area information 710, and generates parameter information 711.

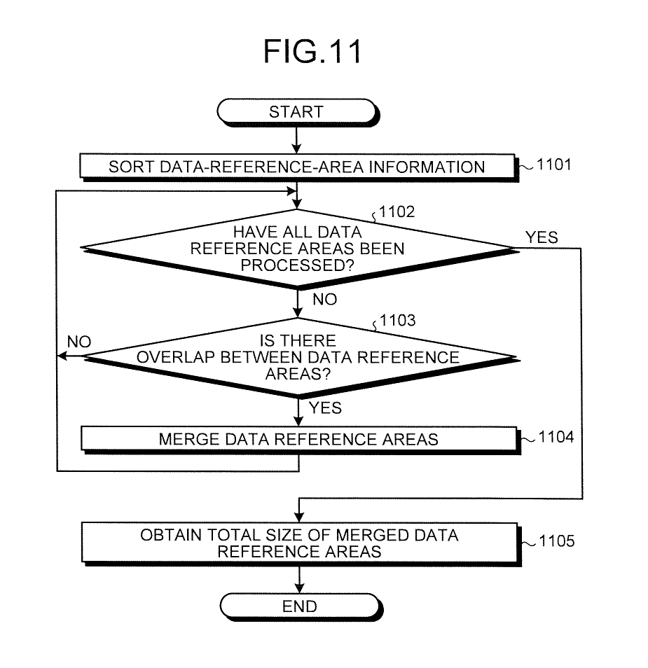

FIG. 11 shows a flowchart for obtaining the data-reference-area size parameter.

First, the data reference areas are sorted in ascending order of the start address (step 1101).

Next, whether all the data reference areas included in the data-reference-area information have been processed is checked (step 1102).

When not all the data reference areas have been processed, whether there is an overlap between the data reference area that is being processed and the data reference area that was just previously processed is checked (step 1103).

When there is an overlap, the two data reference areas are merged. The start address of the data reference area that was just previously processed is set to the start address of the merged data reference area, and the end address of the data reference area that is being processed is set to the end address of the merged data reference area (step 1104). When there is no overlap, the process returns to step 1102.

When, in step 1102, it is determined that all the data reference areas included in the data-reference-area information are processed, the total size of the merged data reference areas is obtained (step 1105). Thus, the data-reference-area size parameter is obtained.

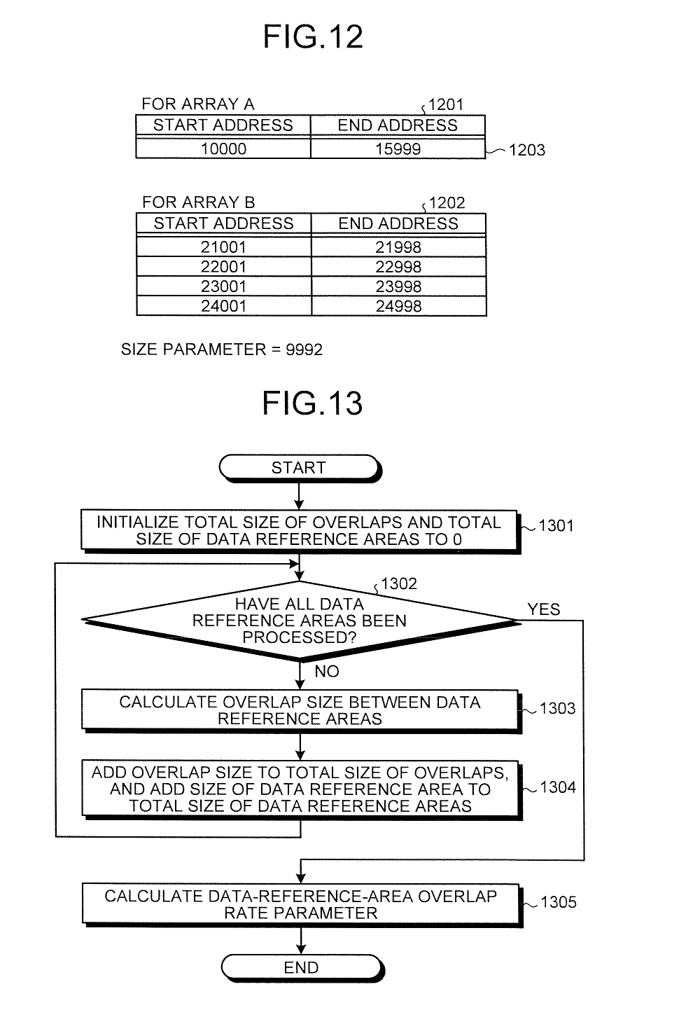

FIG. 12 shows an example of merged data-reference-area information and data-reference-area size parameter. In this case, the data-reference-area size parameter is 6000+998*4=9992.

Next, how to obtain the compute intensity parameter will be described. The compute intensity parameter is obtained by dividing the “the number of arithmetic processing times in a target nested-loop” by “the size of data accessed in the loop”. In the target nested-loop, the number of iterations is (N−2)*(M−2), and arithmetic processing is executed 8 times in each iteration, so that the total number of executions of the arithmetic processing is (N−2)*(M−2)*8=4*998*8=31936 in the nested-loop. On the other hand, the compute intensity parameter is easily obtained as 31936/9992=3.2 because the data accessed in the loop is indicated by the data-reference-area size parameter calculated above.

Next, FIG. 13 shows a flowchart for obtaining the data-reference-area overlap rate parameter.

First, the total size of overlaps and the total size of data reference areas in the data reference areas are initialized to 0 (step 1301). Next, whether all the data reference areas included in the data-reference-area information have been processed is checked (step 1302).

When not all the data reference areas have been processed in step 1302, the overlap size between the data reference area that is being processed and the data reference area that was just previously processed is calculated (step 1303).

The calculated overlap size is added to the total size of overlaps, and the size of the data reference area is added to the total size of data reference areas (step 1304).

The process returns to step 1302, and when all the data reference areas have been processed, the overlap rate is calculated by dividing the total size of overlaps by the total size of data reference areas, and the overlap rate is defined as the data-reference-area overlap rate parameter (step 1305).

In this example, the data-reference-area overlap rate parameter is 67%.

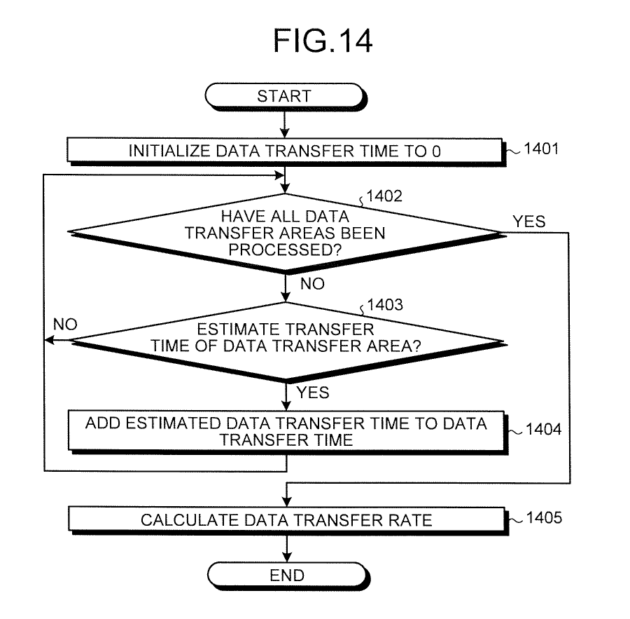

Next, FIG. 14 shows a flowchart for obtaining the data transfer rate parameter.

First, the total data transfer time is initialized to 0 (step 1401). Next, whether all the data transfer areas included in the data-reference-area information have been processed is checked (step 1402).

If not all the data transfer areas have been processed in step 1402, the transfer time of the data transfer area that is being processed is obtained (step 1403). Then, the obtained data transfer time is added to the total data transfer time (step 1404).

The process returns to step 1402, and when all the data transfer areas have been processed, the data transfer rate is calculated, and the data transfer rate is defined as the data transfer rate parameter (step 1405).

According to the flowchart, the data transfer rate parameter is calculated as ((15999-10000+1)+(24998−21001+1))/(t(6000)+t(3998)). It is possible to calculate that t(6000)=326 and t(3998)=234, so that the data transfer rate parameter can be calculated to be 17.9.

As described above, the parameter analysis section 706 obtains the data-reference-area size parameter, the compute intensity parameter, the data-reference-area overlap rate parameter, and the data transfer rate parameter, and then generates parameter information 711.

Return to FIG. 7. An off-load determination section 707 selects a win-loss table generated and stored in advance on the basis of the parameter information 711, and determines whether the processing should be off-loaded to the accelerator processor 104.

The off-load determination section 707 selects a win-loss table nearest to the data-reference-area overlap rate parameter and the data-reference-area size parameter of the parameter information 711 by performing simple interpolation. In this embodiment, since <data-reference-area overlap rate parameter, data-reference-area size parameter>=<67%, 9992>, the win-loss table 601 specified by <50%, 6000> nearest to the <67%, 9992> is selected from four tables by performing simple interpolation.

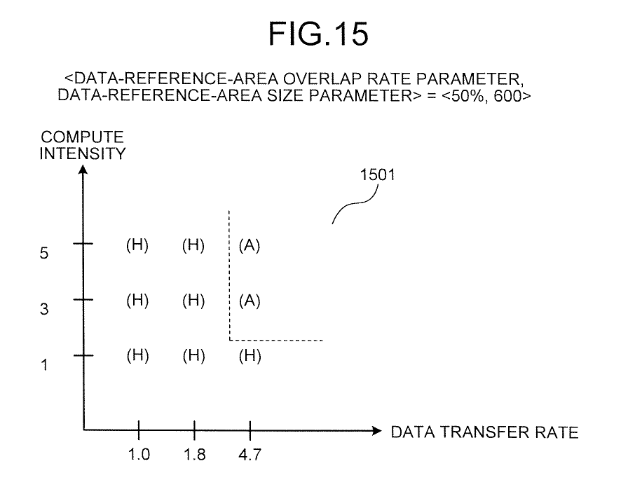

Next, the off-load determination section 707 interpolates the selected win-loss table and creates a win-loss table. In this embodiment, the off-load determination section 707 interpolates the win-loss table and creates a win-loss table 1501 as shown in FIG. 15.

The off-load determination section 707 compares the compute intensity parameter and the data transfer rate parameter of the parameter information 711 with data in the (interpolated) win-loss table, and determines whether the processing should be off-loaded. In this embodiment, since the interpolated win-loss table 1501 shows that the compute intensity=3.2 and the data transfer rate=17.9, the off-load determination section 707 determines that the determination result is (A), in other words, the off-load determination section 707 determines that the processing should be off-loaded. In this embodiment, a win-loss table is stored for each combination of the data-reference-area overlap rate parameter and the data-reference-area size parameter, so that a win-loss table is identified by the data-reference-area overlap rate parameter and the data-reference-area size parameter. However, when a win-loss table is stored for each combination of any other two parameters of the four parameters, a win-loss table may be identified by the other two parameters.

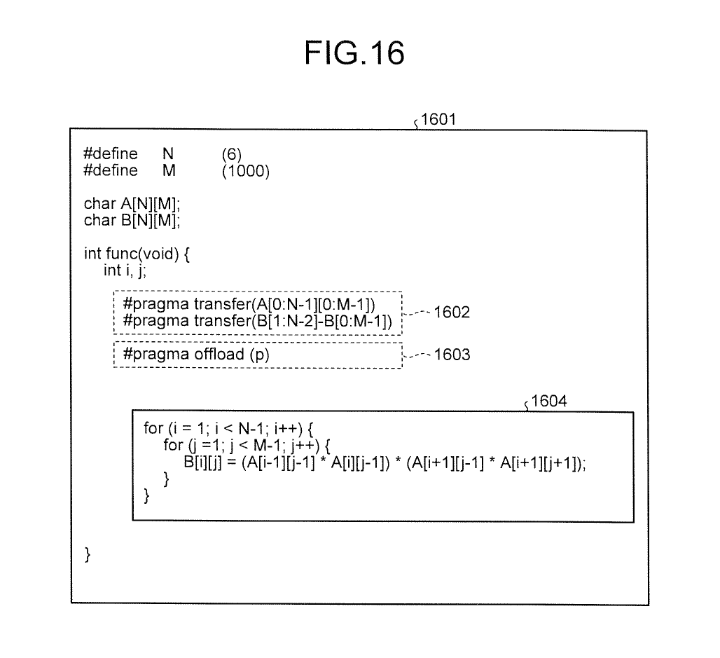

Return to FIG. 7. When a software conversion section 708 receives a determination to off-load the processing from the off-load determination section 707, the software conversion section 708 performs software conversion in which an off-load instruction statement 1603 and a data transfer instruction statement 1602 prepared in advance are inserted in the input software 702, and outputs the output software 703. FIG. 16 shows an example 1601 of the output software 703 generated as a result of the above operation. Although, in this embodiment, the software conversion is performed by inserting a compiler instruction statement, the embodiment is not limited to this.

Although the software conversion program according to the embodiment described above determines whether the software conversion should be performed by using four parameters of the compute intensity, the data reference area size, the data transfer rate, and the data-reference-area overlap rate, (although the precision is lower than the above) it is possible to determine whether the software conversion should be performed by using two parameters of the compute intensity and the data reference area size, or it is possible to determine whether the software conversion should be performed by using three parameters of the compute intensity, the data reference area size, and the data transfer rate.

According to the embodiment described above in detail, it is possible to determine whether the processing should be off-loaded to the accelerator by considering actual change of the data transfer rate and cache behavior in the host processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A software conversion program product having a computer readable medium including programmed instructions, wherein the instructions, when executed by a computer system including a host processor and one or more accelerator processors, causes the computer system to perform:
analyzing input software and obtaining a compute intensity calculated by dividing the number of arithmetic processing times in a loop by the size of data accessed in the loop and a data reference area size that is a total size of areas where data is referred to;
determining a processor that executes loops on the basis of obtained values and a preliminarily prepared win-loss table in which wins and losses of execution times between the host processor and the accelerator processor are defined; and
converting the input software so that the determined processor executes the loops.

2. The program product according to claim 1, further including a programmed instruction that causes the computer system to perform obtaining a data transfer rate indicating a data transfer rate between a main memory of the host processor and an accelerator memory.

3. The program product according to claim 2, further including a programmed instruction that causes the computer system to perform obtaining a data-reference-area overlap rate indicating a degree of overlap of data referred to in loop processing of a test program.

4. The program product according to claim 3, wherein the win-loss table is created by causing the host processor and the accelerator processor, while combining a predetermined plurality of the calculation densities, the data reference area sizes, the data transfer rates, and the data-reference-area overlap rates, to execute a test program to obtain execution times, and determining wins and losses of the execution times between the host processor and the accelerator processor.

5. A computer system comprising:
a host processor;
one or more accelerator processors;
a first obtaining section for analyzing input software and obtaining a compute intensity calculated by dividing the number of arithmetic processing times in a loop by the size of data accessed in the loop;
a second obtaining section for obtaining a data reference area size that is a total size of areas where data is referred to;
a determining section for determining a processor that executes loops in the input software on the basis of values obtained by the first obtaining section and the second obtaining section, and a preliminarily prepared win-loss table in which wins and losses of execution times between the host processor and the accelerator processor are defined; and
a converting section for converting the input software so that the processor determined by the determining section executes the loops.
